(19) United States
(12) Patent Application Publication
(10) Pub. No.: US 2024/0085847 A1
(43) Pub. Date: Mar. 14, 2024

(54) IMAGE FORMING APPARATUS

(71) Applicant: FUJIFILM Business Innovation Corp., Tokyo (JP)

(72) Inventors: Tatsuya KOYAMA, Kanagawa (JP); Ryo WAKAMATSU, Kanagawa (JP); Kenta TSUKAHIRA, Kanagawa (JP); Kenji SUZUKI, Kanagawa (JP); Kazutaka SHIBANO, Kanagawa (JP); Daiki KATO, Kanagawa (JP); Naoyuki KURITA, Kanagawa (JP)

(73) Assignee: FUJIFILM Business Innovation Corp., Tokyo (JP)

(21) Appl. No.: 18/189,197

(22) Filed: Mar. 23, 2023

(30) Foreign Application Priority Data
Sep. 13, 2022 (JP) 2022-145589

(51) Int. Cl. G03G 21/10; G03G 15/00; G03G 15/01; G03G 15/16; G03G 21/00

(52) U.S. Cl. CPC G03G 21/10; G03G 15/01; G03G 15/161; G03G 15/5016; G03G 21/0011; G03G 21/0064

(57) ABSTRACT

An image forming apparatus includes plural image holding bodies that are provided for respective colors of toners and hold toner images having the respective colors, an intermediate transfer body onto which the toner images having the respective colors held by the plural image holding bodies are transferred, a waste toner collection unit that collects toners remaining on the intermediate transfer body as a waste toner in a case where the toner images having the respective colors transferred onto the intermediate transfer body are transferred onto a recording material, a waste toner developing unit that uses the waste toner collected by the waste toner collection unit to develop a toner image on an image holding body of the plural image holding bodies or the other image holding body of the plural image holding bodies, and a control unit that performs a control to cause the waste toner developing unit to develop the toner image in a case where a predetermined condition about a ratio of a waste toner having each color to the waste toner stored in the waste toner collection unit is satisfied.

### CROSS-REFERENCE TO RELATED APPLICATIONS

This application is based on and claims priority under 35 USC 119 from Japanese Patent Application No. 2022-145589 filed Sep. 13, 2022.

### BACKGROUND

### (i) Technical Field

The present invention relates to an image forming apparatus.

### (ii) Related Art

JP2010-152022A discloses an image forming apparatus including a waste toner collection unit that collects a residual toner remaining after the transfer of a toner image as a waste toner and a waste toner developing unit that causes the waste toner collected by the waste toner collection unit to adhere to a photoreceptor, and a control unit performs the integrated control of a toner image forming device including the waste toner developing unit and a transport mechanism to transfer the waste toner onto a recording medium at a predetermined timing. Accordingly, in the image forming apparatus, a burden on a user in a case where work for discarding a waste toner is performed is reduced, and a waste toner is not scattered to the surroundings since the waste toner is discharged in a state where the waste toner is fixed to the recording medium.

### SUMMARY

In a case where printing corresponding to black is performed in the image forming apparatus that forms an image on a recording material using toners, a waste toner may be reused as process black instead of a new black toner. Since a yellow toner, a magenta toner, and a cyan toner are used as toners in addition to a black toner in a general image forming apparatus, a waste toner in which these four types of toners are mixed may be present.

In a case where printing is performed using this waste toner as it is as process black, the reproducibility of black may vary depending on a ratio of a waste toner having each color to the waste toner.

Aspects of non-limiting embodiments of the present disclosure relate to an image forming apparatus that is to improve the reproducibility of black using a waste toner as compared to a case where a waste toner is used without considering a ratio of a waste toner having each color to the waste toner.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: a plurality of image holding bodies that are provided for respective colors of toners and hold toner images having the respective colors; an intermediate transfer body onto which the toner images having the respective colors held by the plurality of image holding bodies are transferred; a waste toner collection unit that collects toners remaining on the intermediate transfer body as a waste toner in a case where the toner images having the respective colors transferred onto the intermediate transfer body are transferred onto a recording material; a waste toner developing unit that uses the waste toner collected by the waste toner collection unit to develop a toner image on an image holding body of the plurality of image holding bodies or the other image holding body of the plurality of image holding bodies; and a control unit that performs a control to cause the waste toner developing unit to develop the toner image in a case where a predetermined condition about a ratio of a waste toner having each color to the waste toner stored in the waste toner collection unit is satisfied.

### BRIEF DESCRIPTION OF THE DRAWINGS

Exemplary embodiment(s) of the present invention will be described in detail based on the following figures, wherein:

FIG. 1 is a diagram showing an outline of an image forming apparatus according to an exemplary embodiment;

FIG. 2 is a block diagram showing a functional configuration example of the image forming apparatus according to the present exemplary embodiment;

FIG. 3 is a flowchart showing the flow of processing of calculating and storing the volume of a waste toner stored in a waste toner container of the present exemplary embodiment;

FIG. 4 is a flowchart showing the flow of processing of performing printing using any of a waste toner or a normal toner in the present exemplary embodiment;

FIG. 5 is a flowchart showing the flow of processing of supplying any of a waste toner or a normal toner of the present exemplary embodiment as a lubricant for a cleaning blade; and

FIG. 6 is a diagram showing the outline of an image forming apparatus according to a modification example of the present exemplary embodiment.

### DETAILED DESCRIPTION

Overall Configuration of Image Forming Apparatus

An exemplary embodiment will be described in detail below with reference to the accompanying drawings.

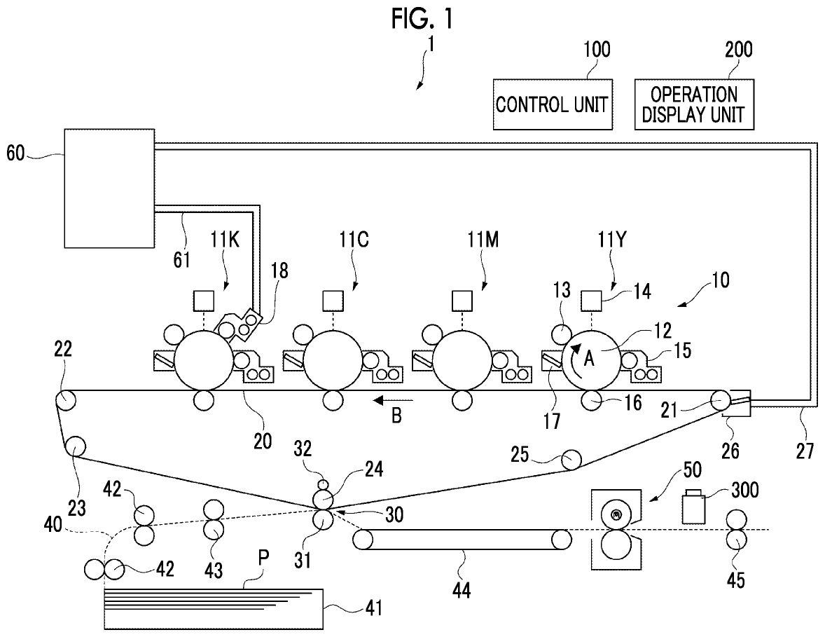

FIG. 1 is a diagram showing an outline of an image forming apparatus 1 according to the present exemplary embodiment.

The image forming apparatus 1 is an image forming apparatus generally called a tandem-type image forming apparatus. The image forming apparatus 1 includes an image forming device 10 that forms images to correspond to image data corresponding to respective colors. Further, the image forming apparatus 1 includes an intermediate transfer belt 20 as an intermediate transfer body to which toner images formed by respective image forming units 11 and having the respective colors are sequentially transferred (primarily transferred) and which holds the toner images. Furthermore, the image forming apparatus 1 includes a secondary transfer device 30 that collectively transfers (secondarily transfers) the toner images transferred onto the intermediate transfer belt 20 to a sheet P as an example of a recording medium. Moreover, the image forming apparatus 1 includes a sheet transport device 40 that feeds and transports a sheet P, and a fixing device 50 that fixes the secondarily transferred toner images to the transported sheet P. In addition, the image forming apparatus 1 includes a control unit 100 that controls each mechanism part of the image forming apparatus 1.

Further, the image forming apparatus 1 includes an operation display unit 200 that is formed of a touch panel or the like, outputs an instruction given from a user to the control unit 100, and presents information output from the control unit 100 to a user.

The image forming device 10 includes a plurality of (four in the present exemplary embodiment) image forming units 11 (specifically, 11Y (yellow), 11M (magenta), 11C (cyan), and 11K (black)) in which the toner images having the respective colors are formed by, for example, an electrophotographic method.

The respective image forming units 11 (11Y, 11M, 11C, and 11K) shown in FIG. 1 have the identical configuration except that the black image forming units 11K includes a waste toner developing unit 18 and the colors of toners to be used are different from each other. Accordingly, the yellow image forming unit 11Y will be described by way of example. The yellow image forming unit 11Y includes a photoreceptor drum 12 as an image holding body that includes a photosensitive layer and is rotatable in a direction of an arrow A. A charging roller 13, a light emitting element head 14, a developing unit 15, a primary transfer roller 16, and a drum cleaner 17 are provided around the photoreceptor drum 12. Among the charging roller 13, the light emitting element head 14, the developing unit 15, the primary transfer roller 16, and the drum cleaner 17, the charging roller 13 is rotatably disposed in contact with the photoreceptor drum 12 and charges the photoreceptor drum 12 to a predetermined potential. The light emitting element head 14 irradiates the photoreceptor drum 12, which is charged by the charging roller 13, with light to write an electrostatic latent image. The developing unit 15 stores a toner having a corresponding color (a yellow toner in the yellow image forming unit 11Y), and develops the electrostatic latent image on the photoreceptor drum 12 with this toner. The primary transfer roller 16 primarily transfers a toner image, which is formed on the photoreceptor drum 12, onto the intermediate transfer belt 20. The drum cleaner 17 removes residues (a residual toner and the like) on the photoreceptor drum 12 subjected to primary transfer.

The black image forming unit 11K to which the present exemplary embodiment is applied further includes a waste toner developing unit 18 as an example of a waste toner developing unit. The waste toner developing unit 18 is a developing unit that is provided separately from the developing unit 15 using a normal black toner and is dedicated to a waste toner, and develops a toner image using a waste toner that is supplied from a waste toner container 60 by a waste toner transport mechanism 61.

The intermediate transfer belt 20 is supported by a plurality of (five in the present exemplary embodiment) support rollers to be rotatable in a direction of an arrow B. Among these support rollers, a drive roller 21 stretches the intermediate transfer belt 20 and drives and rotates the intermediate transfer belt 20. Further, stretching rollers 22 and 25 stretch the intermediate transfer belt 20, and are rotated while following the intermediate transfer belt 20 driven by the drive roller 21. A correction roller 23 functions as a steering roller (provided to be tiltable with one end portion in an axial direction as a fulcrum) that stretches the intermediate transfer belt 20 and restricts a meandering of the intermediate transfer belt 20 in a direction substantially orthogonal to a transport direction. In addition, a backup roller 24 stretches the intermediate transfer belt 20 and functions as a component of the secondary transfer device 30 to be described later.

Further, a cleaning blade 26, which removes residues (toners and the like) on the intermediate transfer belt 20 subjected to secondary transfer, is provided at a portion facing the drive roller 21 with the intermediate transfer belt 20 interposed between the cleaning blade 26 and the drive roller 21. The cleaning blade 26 physically scrapes off the residual toner (waste toner) of the secondary transfer from the moving intermediate transfer belt, and the scraped toner is collected by a waste toner collection mechanism 27 and is stored in the waste toner container 60.

The cleaning blade 26, the waste toner collection mechanism 27, and the waste toner container 60 function as an example of a waste toner collection unit.

The secondary transfer device 30 includes a secondary transfer roller 31 that is disposed on a toner image holding surface of the intermediate transfer belt 20, and a backup roller 24 that is disposed on the back side of the intermediate transfer belt 20 and serves as a counter electrode of the secondary transfer roller 31. A power feed roller 32, which applies a secondary transfer bias having a polarity identical to the charging polarity of the toner, is disposed in contact with the backup roller 24.

Further, the sheet transport device 40 includes a sheet tray 41, transport rollers 42, registration rollers 43, a transport belt 44, and discharge rollers 45. After transporting a sheet P, which is loaded on the sheet tray 41, by the transport rollers 42, the sheet transport device 40 temporarily stops the sheet P by the registration rollers 43 and then sends the sheet P to a secondary transfer position of the secondary transfer device 30 at a predetermined timing. The sheet transport device 40 transports the sheet P subjected to secondary transfer to the fixing device 50 via the transport belt 44, and sends the sheet P, which is discharged from the fixing device 50, to the outside by the discharge rollers 45.

Functional Configuration of Image Forming Apparatus

Next, functions performed by the control unit 100 will be described.

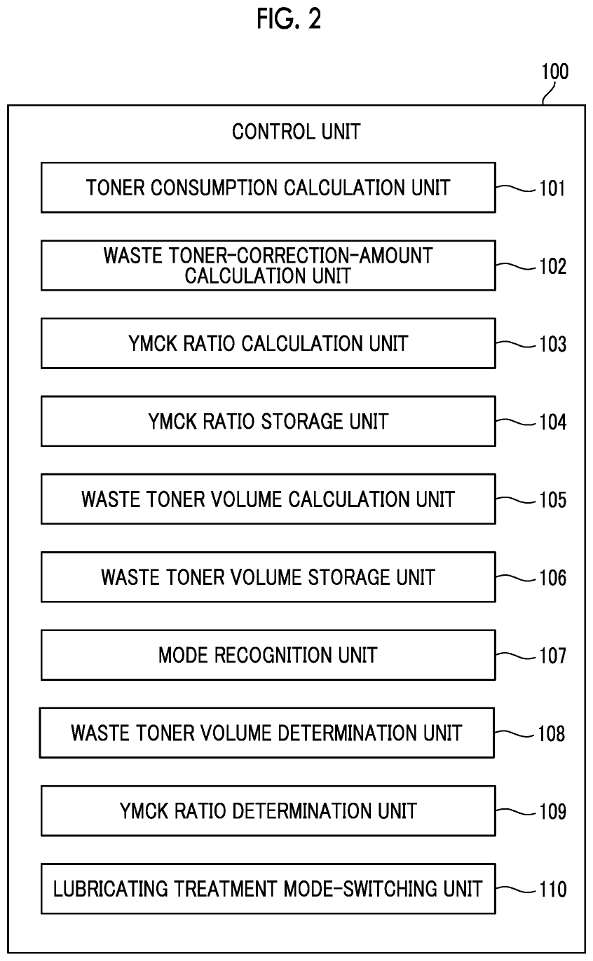

FIG. 2 is a functional configuration diagram illustrating the functions performed by the control unit 100. The control unit 100 includes: a toner consumption calculation unit 101 that calculates the consumption of a toner having each color in each of the image forming units 11 (11Y, 11M, 11C, and 11K); a waste toner-correction-amount calculation unit 102 that calculates the amount of waste toner, which is collected into the waste toner container 60, of the toner having each color used in each of the image forming units 11 (11Y, 11M, 11C, and 11K); a YMCK ratio calculation unit 103 that calculates a ratio of a waste toner having each color of Y, M, C, and K to the waste toner stored in the waste toner container 60 on the basis of the amount of collected waste toner having each color of Y, M, C, and K; a YMCK ratio storage unit 104 that stores the ratio of a waste toner having each color of Y, M, C, and K to the waste toner stored in the waste toner container 60; a waste toner volume calculation unit 105 that calculates the volume of the waste toner stored in the waste toner container 60; and a waste toner volume storage unit 106 that stores the calculated volume of the waste toner. Further, the control unit 100 includes a mode recognition unit 107 that recognizes whether or not a user has set a reuse mode in which a waste toner is used, a waste toner volume determination unit 108 that determines whether or not the volume of the waste toner stored in the waste toner container 60 is equal to or larger than a prescribed volume, and a YMCK ratio determination unit 109 that determines whether or not the ratio of a waste toner having each color to the waste toner stored in the waste toner container 60 satisfies a predetermined condition.

Furthermore, the control unit 100 includes a lubricating treatment mode-switching unit 110 that switches a mode to a mode in which a toner is used as a lubricant for the cleaning blade 26.

Printing Process

Next, a printing process of the present exemplary embodiment will be described.

In the printing process of the present exemplary embodiment, in a case where image information to be printed is obtained, an image is formed with a pixel as the minimum unit by each of the image forming units 11 (11Y, 11M, 11C, and 11K) on the basis of the image information. In each of the image forming units 11 (11Y, 11M, 11C, and 11K), for each color, after exposure is performed on the photoreceptor drum 12, which is charged by the charging roller 13, with a pixel as a unit by the light emitting element head 14 and a toner image is formed by the developing unit 15, the toner image is transferred (primarily transferred) onto the intermediate transfer belt 20. After the toner images having the respective colors are transferred onto the intermediate transfer belt 20, the toner images are transferred (secondarily transferred) onto the sheet P by the secondary transfer device 30. After that, the toner images transferred onto the sheet P are fixed by the fixing device 50.

Meanwhile, the toner remaining on the intermediate transfer belt 20 after the transfer of the toner images onto the sheet P is removed by the cleaning blade 26, is collected by the waste toner collection mechanism 27, and is stored in the waste toner container 60.

In a case where printing using waste toner is performed, the waste toner developing unit 18 is used instead of the developing unit 15 and a toner image is formed using waste toner transported from the waste toner container 60 by the waste toner transport mechanism 61. After that, a printing process is performed in a manner identical to a manner in a case where a normal toner is used.

Use of Waste Toner During Printing

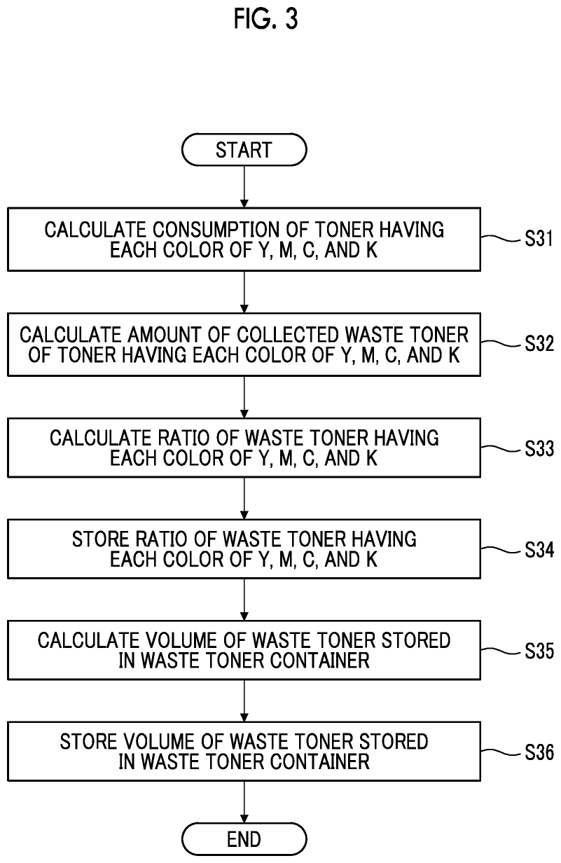

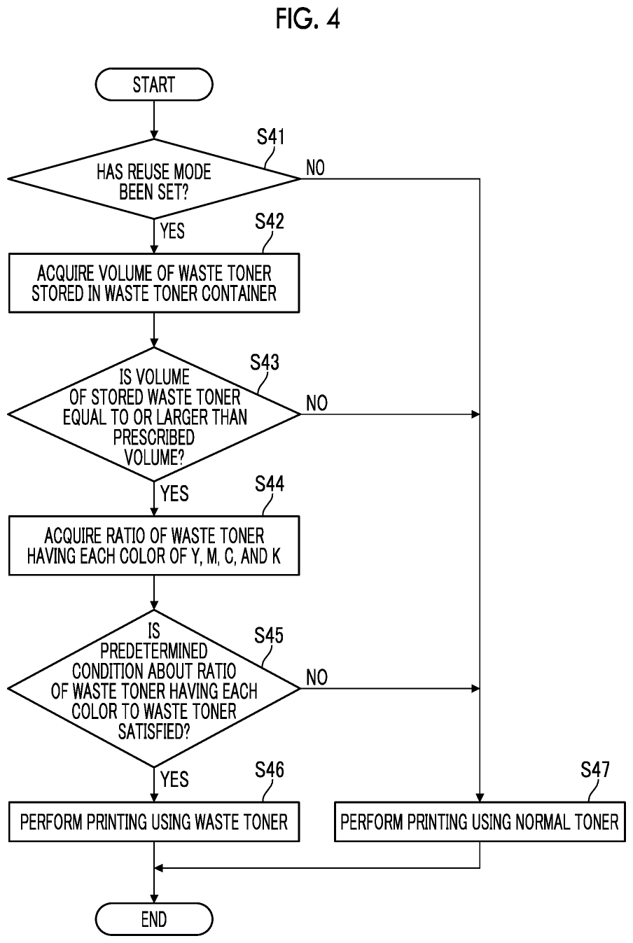

Next, the use of a waste toner during printing in the present exemplary embodiment will be described with reference to FIGS. 3 and 4. FIG. 3 is a flowchart showing the flow of processing of calculating and storing the volume of the waste toner stored in the waste toner container 60. Further, FIG. 4 is a flowchart showing the flow of processing of performing printing using any of a waste toner or a normal toner.

First, the flow of processing of calculating and storing the volume of the waste toner stored in the waste toner container 60 will be described with reference to FIG. 3. The volume of the waste toner stored in the waste toner container 60 is calculated according to the flowchart of FIG. 3 whenever a toner is used.

In FIG. 3, first, in a case where a toner is used, the consumption of a toner having each color in each of the image forming units 11 (11Y, 11M, 11C, and 11K) is calculated by the toner consumption calculation unit 101 of the control unit 100 (Step S31). The amount of toner used in each image forming unit 11 is calculated from the number of pixels exposed to light and the consumption of a toner of each pixel. The consumption of a toner of each pixel is the unique value of the apparatus, and the consumption of a toner having each color is calculated according to the number of pixels exposed to light in a case where a toner is used for printing or in a case where a toner is used as a lubricant for the cleaning blade 26. In a case where the consumption of a toner of each pixel differs in each image forming unit 11, the amount of toner used in each image forming unit 11 is calculated using a value corresponding to each color.

Next, the amount of waste toner, which is collected into the waste toner container 60, of the toner having each color used in each of the image forming units 11 (11Y, 11M, 11C, and 11K) is calculated by the waste toner-correction-amount calculation unit 102 of the control unit 100 (Step S32). The amount of collected waste toner having each color is calculated on the basis of the amount of toner used in the image forming unit 11 corresponding to each color and a waste toner container-collection ratio of a toner, which is collected as a waste toner without being transferred onto the sheet P, to the toner. The waste toner container-collection ratio is the unique value of the apparatus, and the amount of collected waste toner having each color is calculated according to the consumption of a toner having each color calculated in Step S31.

For example, in a case where the number of pixels exposed to light during printing is 100 kPixel in an image forming apparatus in which the consumption of a toner of each pixel is 28 mg/kPixel and a waste toner container-collection ratio in a case where a toner is used for printing is 9%, the consumption of a toner is 100 kPixel×28 mg/kPixel and the amount of collected waste toner is calculated as 252 mg that is 9% of the consumption of a toner.

Further, in a case where the number of pixels exposed to light in a case where a toner is used as a lubricant is 0.139 kPixel in an image forming apparatus in which the consumption of a toner of each pixel is 28 mg/kPixel and a waste toner container-collection ratio in a case where a toner is used as a lubricant for the cleaning blade 26 is 90%, the consumption of a toner is 0.139 kPixel×28 mg/kPixel and the amount of collected waste toner is calculated as 3.5 mg that is 90% of the consumption of a toner.

Subsequently, a ratio of a waste toner having each color of Y, M, C, and K to the waste toner stored in the waste toner container 60 is calculated by the YMCK ratio calculation unit 103 of the control unit 100 (Step S33). The ratio of a waste toner having each color of Y, M, C, and K to the waste toner refers to a ratio of the amount of toner, which has each color (each of yellow, magenta, cyan, and black in the present exemplary embodiment), to the amount of waste toner stored in the waste toner container. The ratio of a waste toner having each color to the waste toner is calculated on the basis of the amount of waste toner, which is collected into the waste toner container 60, of the toner having each color used in the image forming unit 11 corresponding to each color. The calculated ratio of a waste toner having each color of Y, M, C, and K to the waste toner is stored in the YMCK ratio storage unit 104 of the control unit 100 (Step S34).

Subsequently, the volume of the waste toner stored in the waste toner container 60 is calculated by the waste toner volume calculation unit 105 of the control unit 100 (Step S35). The sum of the amounts of collected waste toner having the respective colors calculated in Step S32 is added to the volume of the waste toner stored in the waste toner container 60, so that the volume of the waste toner stored in the waste toner container 60 is calculated. The calculated volume of the waste toner stored in the waste toner container 60 is stored in the waste toner volume storage unit 106 of the control unit 100 (Step S36).

Next, the flow of processing of performing printing using any of a waste toner or a normal toner will be described with reference to FIG. 4.

In FIG. 4, first, in a case where a printing process is started, the mode recognition unit 107 of the control unit 100 determines whether or not a user has set a reuse mode in which a waste toner is used (Step S41). Here, the reuse mode is a mode in which printing is performed using a waste toner, and a user may set the reuse mode from, for example, the operation display unit 200 (see FIG. 1) in the present exemplary embodiment. In a case where the mode recognition unit 107 determines that the user has not set the reuse mode (NO in Step S41), printing is performed using a normal toner without using the waste toner (Step S47). In a case where the mode recognition unit 107 determines that the user has set the reuse mode (YES in Step S41), the printing process proceeds to Step S42 and the waste toner volume determination unit 108 of the control unit 100 acquires the volume of the waste toner stored in the waste toner container 60 which is stored in the waste toner volume storage unit 106. In a case where the image forming apparatus is adapted to use a waste toner without setting the reuse mode whenever printing is performed in a case where a user sets the reuse mode once, the user may reduce the consumption of a new toner without paying particular attention to a toner.

Subsequently, the waste toner volume determination unit 108 of the control unit 100 determines whether or not the volume of the waste toner stored in the waste toner container 60 is equal to or larger than a prescribed volume (Step S43). In a case where the waste toner volume determination unit 108 determines that the volume of the stored waste toner is smaller than the prescribed volume (NO in Step S43), printing is performed using a normal toner without using the waste toner (Step S47). In a case where the waste toner volume determination unit 108 determines that the volume of the stored waste toner is equal to or larger than the prescribed volume (YES in Step S43), the printing process proceeds to Step S44 and the YMCK ratio determination unit 109 of the control unit 100 acquires a ratio of a waste toner having each color of Y, M, C, and K to the waste toner stored in the waste toner container 60 which is stored in the YMCK ratio storage unit 104.

The prescribed volume as a criterion for determination in Step S43 is determined on the basis of the amount of waste toner to be used for one time in a case where a waste toner is used. For example, the volume as a criterion for determination is defined as 10 times the amount of waste toner to be used for printing.

Subsequently, the YMCK ratio determination unit 109 of the control unit 100 determines whether or not a predetermined condition about a ratio of a waste toner having each color to the waste toner stored in the waste toner container 60 is satisfied (Step S45). In a case where the YMCK ratio determination unit 109 determines that the predetermined condition is not satisfied (NO in Step S45), printing is performed using a normal toner without using the waste toner (Step S47). In a case where the YMCK ratio determination unit 109 determines that the predetermined condition is satisfied (YES in Step S45), printing is performed using the waste toner (Step S46).

The predetermined condition about a ratio of a waste toner having each color to the waste toner is determined on the basis of whether or not an image printed using the waste toner can be used as a black image. That is, in a case where the waste toner is regarded as a black toner and can be used instead of a black toner, it is determined that the predetermined condition about a ratio of a waste toner having each color to the waste toner is satisfied. Accordingly, printing using the waste toner is performed.

A case where the waste toner is regarded as a black toner and can be used instead of a black toner is a case where, for example, a ratio of a black waste toner to the waste toner is 50% or more. In this case, since the waste toner may be regarded as a black toner regardless of ratios of waste toners having colors other than black to the waste toner, printing may be performed using the waste toner instead of a black toner.

Further, even in a case where ratios of waste toners having colors other than black to the waste toner are in a range where the amounts of waste toners may be regarded to be equal to each other, printing may be performed using the waste toner instead of a black toner. The range where the amounts of waste toners can be regarded to be equal to each other is set in advance, and is defined such that, for example, a difference in a ratio of the amount of waste toner having each color of yellow, magenta, and cyan to the amount of waste toner is within 3%. In a case where ratios of a yellow waste toner, a magenta waste toner, and a cyan waste toner to the waste toner are in the range where the amounts of waste toners can be regarded to be equal to each other, the waste toner can be regarded as a black toner regardless of a ratio of a black waste toner. Accordingly, printing can be performed using the waste toner instead of a black toner.

A case where a ratio of a black waste toner to the waste toner is 50% or more and a case where ratios of waste toners having colors other than black to the waste toner are in the range where the amounts of waste toners can be regarded to be equal to each other have been described as a case where the waste toner is regarded as a black toner and can be used instead of a black toner, by way of example. However, the case where the waste toner is regarded as a black toner and can be used instead of a black toner is not limited thereto. A range where an image printed using the waste toner can be used as a black image may be adapted to be capable of being set by a user's operation. For example, a user can set this range using an input from the operation display unit 200 such that printing is performed using the waste toner in a case where a ratio of a black waste toner to the waste toner is 40% or more.

With this configuration, it is possible to determine to what extent the reproducibility of a black color is allowed depending on the intended use and the purpose, according to the user's setting.

As described so far, in a case where the control unit 100 controls printing using waste toner in the present exemplary embodiment, there are provided three criteria for determination, that is, whether or not a user has set a reuse mode in which a waste toner is used, whether or not the volume of the waste toner stored in the waste toner container 60 is equal to or larger than a prescribed volume, and whether or not a predetermined condition about a ratio of a waste toner having each color to the waste toner is satisfied.

As shown in the flowchart of FIG. 4, in the present exemplary embodiment, the control unit 100 performs a control such that printing using the waste toner is performed in a case where all these criteria for determination are satisfied. However, the control of printing using the waste toner performed by the control unit 100 is not limited to this form, and a control may be performed in a form in which the three criteria for determination are combined as necessary.

For example, Steps S41 and S43 may be omitted, and the image forming apparatus may be adapted to perform printing using the waste toner as a black toner in a case where a predetermined condition about a ratio of a waste toner having each color to the waste toner is satisfied. Further, only one of the Steps S41 and S43 may be omitted.

Furthermore, in a case where printing can be performed using the waste toner since a user has not set the reuse mode and the other two criteria for determination other than the reuse mode are satisfied, the control unit 100 may be adapted to notify the user that the reuse mode can be set. According to this configuration, a user may know whether or not it is a situation where the waste toner may be used, and may select the reuse mode in a case where a situation is changed to a situation where the waste toner may be used from a situation where the waste toner may not be used.

Moreover, in a case where a ratio of a waste toner having each color to the waste toner does not satisfy a condition where the waste toner is used for printing, the control unit 100 may be adapted to perform a control to forcibly change a toner having a color, which does not satisfy the condition, into a waste toner. The control to forcibly change a toner as the waste toner is, for example, a control to use a toner having a color, which does not satisfy the condition, as a lubricant for the cleaning blade 26. An example of the image forming apparatus 1, which can perform printing using a waste toner instead of a black toner in a case where ratios of waste toners having colors other than black to the waste toner are in the range where the amounts of waste toners can be regarded to be equal to each other, will be described.

For example, in the image forming apparatus 1 in which the range where the amounts of waste toners can be regarded to be equal to each other is defined such that a difference in a ratio of the amount of waste toner having each color of yellow, magenta, and cyan to the amount of waste toner is within 3%, it is assumed that ratios of a yellow waste toner, a magenta waste toner, and a cyan waste toner to the waste toner are 25%, 25%, and 20%, respectively. Since a difference in a ratio of the amount of waste toner having each color to the amount of waste toner is not within 3% in this case and the waste toner cannot be regarded as a black toner, the waste toner is not used during printing and printing using a normal toner is performed. It is necessary to increase the ratio of a cyan waste toner in order to satisfy a condition where the waste toner is regarded as a black toner and is used for printing. Accordingly, the control unit 100 performs a control that causes a cyan toner to be used as a lubricant for the cleaning blade 26 to increase the ratio of a cyan waste toner to the waste toner and to satisfy a condition where the waste toner is used for printing.

In a case where a ratio of a waste toner having each color does not satisfy a condition where the waste toner is used for printing as described above, a control for causing the condition to be satisfied may be performed to facilitate the efficient use of the waste toner.

### EXAMPLES

An example of the image forming apparatus 1 in which a control to perform printing using a waste toner is performed in a case where all the three criteria for determination are satisfied will be described.

For example, in a case where a user sets a reuse mode in a new image forming apparatus 1, a waste toner is not used until the volume of the waste toner satisfies a prescribed volume. In a case where the volume of the stored waste toner is equal to or larger than the prescribed volume and a ratio of a waste toner having each color to the waste toner satisfies the condition, the waste toner is regarded as a black toner and is used to perform printing.

Even in a case where a reuse mode is set after the image forming apparatus 1 is used to some extent, the waste toner is not used until the conditions of the volume of the waste toner and a ratio of a waste toner having each color are satisfied. The amount of used toner is calculated regardless of whether or not the reuse mode is set. In a case where the volume of the stored waste toner is equal to or larger than the prescribed volume and a ratio of a waste toner having each color to the waste toner satisfies the condition, the waste toner is regarded as a black toner and is used to perform printing.

Further, in a case where the reuse mode is set and the waste toner is used, the condition where the waste toner is used for printing may not be satisfied due to a reduction in the volume of the waste toner or a change in a ratio of a waste toner having each color to the waste toner. In this case, a control returns to a control to use a normal toner. Then, in a case where the condition is satisfied again, the waste toner is regarded as a black toner and is used to perform printing.

Lubricant Supply Process

Next, a process for supplying a toner to the cleaning blade 26 during the use of a toner as a lubricant for the cleaning blade 26 will be described. The image forming apparatus 1 switches a mode to a lubricating treatment mode from a printing processing mode by the lubricating treatment mode-switching unit 110 for switching a mode to a mode in which a toner is used as a lubricant for the cleaning blade 26, so that a lubricant supply process is started.

A toner image, which is formed to be supplied to the cleaning blade 26 as a lubricant for the cleaning blade 26, will be referred to as a toner image for a lubricant in the following description. The toner image for a lubricant is developed by the image forming unit 11 as with a normal toner image, and is primarily transferred onto the intermediate transfer belt 20. The toner image for a lubricant primarily transferred onto the intermediate transfer belt 20 is transported to the secondary transfer position with the rotation of the intermediate transfer belt 20.

Meanwhile, a sheet P is not transported to the secondary transfer position unlike in the case of normal printing and the toner image for a lubricant is not secondarily transferred onto a sheet P. The toner image for a lubricant is supplied to the cleaning blade 26 as it is, and functions as a lubricant. Further, in a case where a region on the intermediate transfer belt 20 in which the toner image for a lubricant is formed is in contact with the secondary transfer roller 31 at the secondary transfer position, the backup roller 24 applies a voltage having a polarity opposite to a polarity used in the case of normal printing. Accordingly, the adhesion of the toner of the toner image for a lubricant to the secondary transfer roller 31 is suppressed. The secondary transfer roller 31 may be separated from the intermediate transfer belt 20 to suppress the adhesion of the toner to the secondary transfer roller 31.

Any of a yellow toner, a magenta toner, a cyan toner, or a black toner may be used as a lubricant for the cleaning blade 26. In a case where a waste toner is used as a lubricant, the waste toner developing unit 18 is driven instead of the developing unit 15 and a toner image for a lubricant is formed using a waste toner that is transported from the waste toner container 60 by the waste toner transport mechanism 61. After that, a lubricant supply process is performed as in a case where a normal toner is used.

Use of Waste Toner as Lubricant

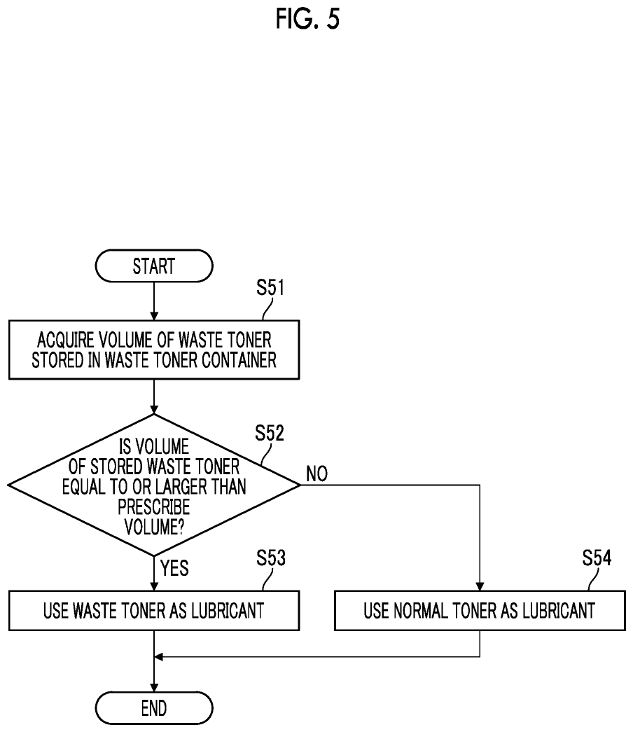

Next, the flow of processing of supplying either of a waste toner or a normal toner as a lubricant for the cleaning blade will be described with reference to FIG. 5.

In FIG. 5, first, in a case where the lubricant supply process is started, the waste toner volume determination unit 108 of the control unit 100 acquires the volume of the waste toner stored in the waste toner container 60 which is stored in the waste toner volume storage unit 106 (Step S51).

Subsequently, the waste toner volume determination unit 108 of the control unit 100 determines whether or not the volume of the waste toner stored in the waste toner container 60 is equal to or larger than a prescribed volume (Step S52). In a case where the waste toner volume determination unit 108 determines that the volume of the stored waste toner is smaller than the prescribed volume (NO in Step S52), the waste toner is not used and a normal toner is supplied as a lubricant (Step S54). In a case where the waste toner volume determination unit 108 determines that the volume of the stored waste toner is equal to or larger than the prescribed volume (YES in Step S52), the waste toner is supplied as a lubricant (Step S53).

The prescribed volume as a criterion for determination in Step S52 is determined on the basis of the amount of waste toner to be used for one time in a case where a waste toner is used. The volume as a criterion for determination is defined as, for example, 100 times the amount of waste toner to be used for one time in a case where the waste toner is used as a lubricant for the cleaning blade 26.

In a case where toner is used as a lubricant for the cleaning blade 26, the waste toner can be used in a case where the volume of the stored waste toner is equal to or larger than a predetermined volume regardless of whether or not the reuse mode is set and a ratio of a waste toner having each color to the waste toner. According to this configuration, since the waste toner is used as a lubricant for the cleaning blade 26 even in a case where a ratio of a waste toner having each color to the waste toner does not satisfy a condition where the waste toner is used for printing, the consumption of a new toner may be reduced.

In the present exemplary embodiment, the volume of the waste toner stored in the waste toner container 60 has been calculated on the basis of the amount of toner used in the image forming unit 11 corresponding to each color and a waste toner container-collection ratio of a toner, which is collected as a waste toner without being transferred onto the sheet P, to the toner. However, the present invention is not limited to this form. Since a waste toner is used regardless of a ratio of a waste toner having each color to the waste toner in a case where toner is used as a lubricant, the amount of used toner having each color does not need to be calculated and the volume of the waste toner may be detected by a sensor mounted on the waste toner container 60, or the like.

### Modification Example

The black image forming unit 11K is provided with the waste toner developing unit 18 in FIG. 1, but the present invention is not limited to this form. An image forming unit 11PK exclusively using the waste toner is provided, and a configuration in which a toner image is developed with the waste toner may be employed in an image holding body provided in the image forming unit 11PK.

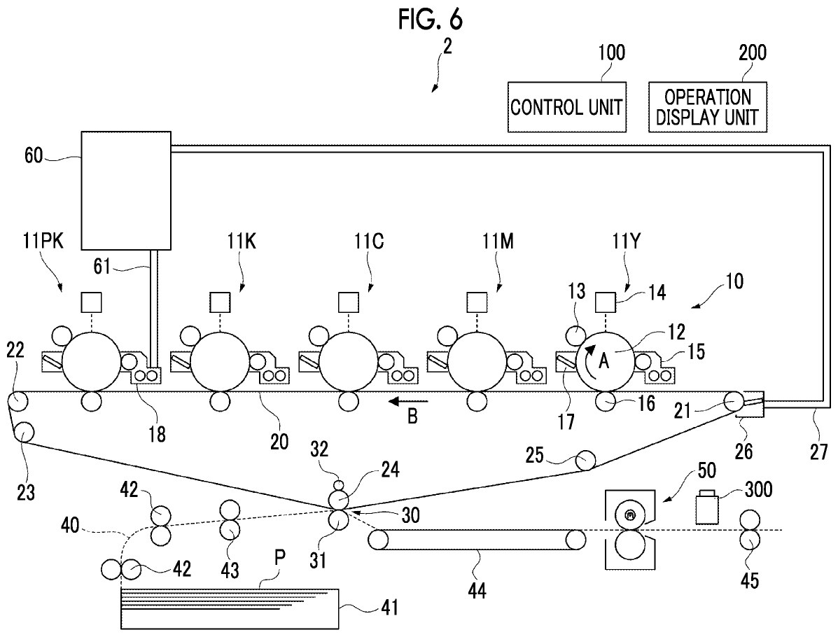

A modification example of the present exemplary embodiment will be described with reference to FIG. 6. FIG. 6 is a diagram showing the outline of an image forming apparatus 2 according to a modification example of the present exemplary embodiment.

The description of a configuration identical to the configuration shown in FIG. 1 will be omitted. As shown in FIG. 6, the image forming apparatus 2 includes an image forming unit 11PK, which exclusively uses the waste toner, on the downstream side of the image forming unit 11K in a rotating direction of the intermediate transfer belt 20. The image forming unit 11PK includes a waste toner developing unit 18, and develops a toner image with the waste toner that is supplied from a waste toner container 60 by a waste toner transport mechanism 61.

In a case where printing using the waste toner is performed in this configuration, the image forming unit 11K is stopped and the image forming unit 11PK is driven instead. Since the image forming unit 11PK is provided on the downstream side of the other image forming units 11 (11Y, 11M, 11C, and 11K) in the rotating direction of the intermediate transfer belt 20, a toner image formed by the image forming unit 11PK and transferred onto the intermediate transfer belt 20 does not come into contact with the other image forming units 11 (11Y, 11M, 11C, and 11K). For this reason, it is possible to prevent the waste toner from adhering to the other image forming units 11 (11Y, 11M, 11C, and 11K).

The present exemplary embodiment has been described above, but the technical scope of the present invention is not limited to the scope described in the above-mentioned exemplary embodiment. The technical scope of the present invention also includes embodiments that are modified and improved in various ways from the above-mentioned exemplary embodiment.

Supplementary Note

(((1)))

An image forming apparatus comprising:
a plurality of image holding bodies that are provided for respective colors of toners and hold toner images having the respective colors;
an intermediate transfer body onto which the toner images having the respective colors held by the plurality of image holding bodies are transferred;
a waste toner collection unit that collects toners remaining on the intermediate transfer body as a waste toner in a case where the toner images having the respective colors transferred onto the intermediate transfer body are transferred onto a recording material;
a waste toner developing unit that uses the waste toner collected by the waste toner collection unit to develop a toner image on an image holding body of the plurality of image holding bodies or the other image holding body of the plurality of image holding bodies; and a control unit that performs a control to cause the waste toner developing unit to develop the toner image in a case where a predetermined condition about a ratio of a waste toner having each color to the waste toner stored in the waste toner collection unit is satisfied.

(((2)))

The image forming apparatus according to (((1))),
wherein the predetermined condition about the ratio of a waste toner having each color to the waste toner in the control unit is determined on the basis of whether or not an image printed using the waste toner is capable of being used as a black image.

(((3)))

The image forming apparatus according to (((2))),
wherein the predetermined condition about the ratio of a waste toner having each color to the waste toner in the control unit is a condition where a ratio of a black waste toner is 50% or more.

(((4)))

The image forming apparatus according to (((2))),
wherein the predetermined condition about the ratio of a waste toner having each color to the waste toner in the control unit is a condition where ratios of waste toners having colors other than black to the waste toner are in a predetermined range where amounts of waste toners are regarded to be equal to each other.

(((5)))

The image forming apparatus according to (((4))),
wherein the control unit performs a control to forcibly change a toner having a color, which does not satisfy the condition, into a waste toner in a case where the ratios of waste toners having colors other than black to the waste toner are not in the predetermined range where the amounts of waste toners are regarded to be equal to each other.

(((6)))

The image forming apparatus according to (((5))),
wherein the control to forcibly change the toner into a waste toner performed by the control unit is to use the toner having the color, which does not satisfy the condition, as a lubricant for a cleaning blade that collects the waste toner remaining on the intermediate transfer body.

(((7)))

The image forming apparatus according to (((2))),
wherein the predetermined condition about the ratio of a waste toner having each color to the waste toner in the control unit is set by a user.

(((8)))

The image forming apparatus according to (((1))),
wherein the control unit calculates the ratio of a waste toner having each color to the waste toner, which is stored in the waste toner collection unit, on the basis of an amount of a toner used in the image holding body corresponding to each color.

(((9)))

The image forming apparatus according to (((8))),
wherein the amount of the toner used in the image holding body corresponding to each color is calculated on the basis of the number of pixels, which are exposed to light and correspond to each color, and consumption of the toner of each of the pixels exposed to light.

(((10)))

The image forming apparatus according to (((1))),
wherein the control unit performs a control to cause the waste toner developing unit to develop the toner image in a case where a volume of the waste toner stored in the waste toner collection unit is equal to or larger than a volume predetermined on the basis of an amount of the waste toner used during a use of the waste toner.

(((11)))

The image forming apparatus according to (((10))),
wherein the volume of the waste toner is calculated on the basis of an amount of a toner used in the image holding body corresponding to each color and a collection ratio of a toner, which is collected as a waste toner, to the toner used in the image holding body corresponding to each color.

(((12)))

The image forming apparatus according to (((1))),
wherein the control unit performs a control to cause the waste toner developing unit to develop the toner image in a case where a user sets a reuse mode in which the waste toner is used.

(((13)))

The image forming apparatus according to (((12))),
wherein the control unit notifies the user that the reuse mode is capable of being used in a case where the predetermined condition about the ratio of a waste toner having each color to the waste toner is satisfied.

(((14)))

The image forming apparatus according to (((1))),
wherein even though the ratio of a waste toner having each color to the waste toner stored in the waste toner collection unit does not satisfy the predetermined condition about the ratio of a waste toner having each color to the waste toner, the control unit uses the waste toner as a lubricant for a cleaning blade that collects the waste toner remaining on the intermediate transfer body in a case where volume of the stored waste toner is equal to or larger than a predetermined volume.

(((15)))

The image forming apparatus according to (((1))),
wherein the control unit performs a control to use a black toner in a case where the ratio of a waste toner having each color to the waste toner stored in the waste toner collection unit is out of the predetermined condition about the ratio of a waste toner having each color to the waste toner.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of image holding bodies that are provided for respective colors of toners and hold toner images having the respective colors;
an intermediate transfer body onto which the toner images having the respective colors held by the plurality of image holding bodies are transferred;
a waste toner collection unit that collects toners remaining on the intermediate transfer body as a waste toner in a case where the toner images having the respective colors transferred onto the intermediate transfer body are transferred onto a recording material;
a waste toner developing unit that uses the waste toner collected by the waste toner collection unit to develop a toner image on an image holding body of the plurality of image holding bodies or the other image holding body of the plurality of image holding bodies; and
a control unit that performs a control to cause the waste toner developing unit to develop the toner image in a case where a predetermined condition about a ratio of a waste toner having each color to the waste toner stored in the waste toner collection unit is satisfied.

2. The image forming apparatus according to claim 1,
wherein the predetermined condition about the ratio of a waste toner having each color to the waste toner in the control unit is determined on the basis of whether or not an image printed using the waste toner is capable of being used as a black image.

3. The image forming apparatus according to claim 2,
wherein the predetermined condition about the ratio of a waste toner having each color to the waste toner in the control unit is a condition where a ratio of a black waste toner is 50% or more.

4. The image forming apparatus according to claim 2,
wherein the predetermined condition about the ratio of a waste toner having each color to the waste toner in the control unit is a condition where ratios of waste toners having colors other than black to the waste toner are in a predetermined range where amounts of waste toners are regarded to be equal to each other.

5. The image forming apparatus according to claim 4,
wherein the control unit performs a control to forcibly change a toner having a color, which does not satisfy the condition, into a waste toner in a case where the ratios of waste toners having colors other than black to the waste toner are not in the predetermined range where the amounts of waste toners are regarded to be equal to each other.

6. The image forming apparatus according to claim 5,
wherein the control to forcibly change the toner into a waste toner performed by the control unit is to use the toner having the color, which does not satisfy the condition, as a lubricant for a cleaning blade that collects the waste toner remaining on the intermediate transfer body.

7. The image forming apparatus according to claim 2,
wherein the predetermined condition about the ratio of a waste toner having each color to the waste toner in the control unit is set by a user.

8. The image forming apparatus according to claim 1,
wherein the control unit calculates the ratio of a waste toner having each color to the waste toner, which is stored in the waste toner collection unit, on the basis of an amount of a toner used in the image holding body corresponding to each color.

9. The image forming apparatus according to claim 8,
wherein the amount of the toner used in the image holding body corresponding to each color is calculated on the basis of the number of pixels, which are exposed to light and correspond to each color, and consumption of the toner of each of the pixels exposed to light.

10. The image forming apparatus according to claim 1,
wherein the control unit performs a control to cause the waste toner developing unit to develop the toner image in a case where a volume of the waste toner stored in the waste toner collection unit is equal to or larger than a volume predetermined on the basis of an amount of the waste toner used during a use of the waste toner.

11. The image forming apparatus according to claim 10,
wherein the volume of the waste toner is calculated on the basis of an amount of a toner used in the image holding body corresponding to each color and a collection ratio of a toner, which is collected as a waste toner, to the toner used in the image holding body corresponding to each color.

12. The image forming apparatus according to claim 1,
wherein the control unit performs a control to cause the waste toner developing unit to develop the toner image in a case where a user sets a reuse mode in which the waste toner is used.

13. The image forming apparatus according to claim 12,
wherein the control unit notifies the user that the reuse mode is capable of being used in a case where the predetermined condition about the ratio of a waste toner having each color to the waste toner is satisfied.

14. The image forming apparatus according to claim 1,
wherein even though the ratio of a waste toner having each color to the waste toner stored in the waste toner collection unit does not satisfy the predetermined condition about the ratio of a waste toner having each color to the waste toner, the control unit uses the waste toner as a lubricant for a cleaning blade that collects the waste toner remaining on the intermediate transfer body in a case where volume of the stored waste toner is equal to or larger than a predetermined volume.

15. The image forming apparatus according to claim 1,
wherein the control unit performs a control to use a black toner in a case where the ratio of a waste toner having each color to the waste toner stored in the waste toner collection unit is out of the predetermined condition about the ratio of a waste toner having each color to the waste toner.
